(19) United States
(12) Patent Application Publication
(10) Pub. No.: US 2014/0068180 A1
(43) Pub. Date: Mar. 6, 2014

(54) DATA ANALYSIS SYSTEM

(71) Applicant: International Business Machines Corporation, Armonk, NY (US)

(72) Inventors: Tsung-Hsuan Hsieh, Taipei (TW); Kuei Huang Liu, Taipei (TW)

(21) Appl. No.: 13/926,108

(22) Filed: Jun. 25, 2013

(30) Foreign Application Priority Data
Aug. 31, 2012 (TW) 101131885

(51) Int. Cl. G06F 12/08

(52) U.S. Cl. CPC G06F 12/0866
USPC 711/113

(57) ABSTRACT

A data analysis system, particularly, a system capable of efficiently analyzing big data is provided. The data analysis system includes an analyst server, at least one data storage unit, a client terminal independent of the analyst server, and a caching device independent of the analyst server. The caching device includes a caching memory, a data transmission interface, and a controller for obtaining a data access pattern of the client terminal with respect to the at least one data storage unit, performing caching operations on the at least one data storage unit according to a caching criterion to obtain and store cache data in the caching memory, and sending the cache data to the analyst server via the data transmission interface, such that the analyst server analyzes the cache data to generate an analysis result, which may be used to request a change in the caching criterion.

### CROSS-REFERENCE TO RELATED APPLICATIONS

This application claims priority under 35 U.S.C. §119 from Taiwan Patent Application No. 101131885, filed on Aug. 31, 2012, the entire text of which is specifically incorporated by reference herein.

### BACKGROUND

1. Field of the Invention

The present invention relates to data analysis systems, and more particularly, to a system for analyzing big data according to caching criteria of a caching device.

2. Background of the Related Art

With information devices being in wide use, data sources nowadays are becoming more abundant. In addition to conventional manual input and system computation, data is generated at every moment as a result of the Internet, the emergence of cloud computing, the rapid development of mobile computing and the Internet of Things (IOT), and the ubiquitous mobile apparatuses, RFID, and wireless sensors.

Big data cannot work by itself. A large storage unit is required to provide sufficient data storage space. A caching device, especially a solid-state storage device, typically stores data replicas in the large storage unit (for example, a hard disk drive) to speed up data access of the system.

### BRIEF SUMMARY

One embodiment of the present invention provides a data analysis system comprising an analyst server, at least one data storage unit, a client terminal independent of the analyst server, and a caching device independent of the analyst server. The caching device comprises a cache memory, a data transmission interface, and a controller in communication with the analyst server, the client terminal, and the storage unit. The controller obtains a data access pattern of the client terminal with respect to the storage unit and performs caching operations on the storage unit according to a caching criterion to obtain and store cache data in the cache memory and send the cache data to the analyst server via the data transmission interface, thereby allowing the analyst server to analyze the cache data and generate an analysis result.

Another embodiment of the present invention provides a caching device comprising a cache memory, a data transmission interface, and a controller connected to the cache memory and the data transmission interface. The controller obtains a data access pattern of a client terminal with respect to a storage unit and performs caching operations on the storage unit according to a caching criterion to obtain and store cache data in the cache memory and send the cache data to an analyst server via the data transmission interface.

Yet another embodiment of the present invention provides a data processing method comprising: (a) obtaining a data access pattern of a client terminal with respect to a data storage unit, (b) performing caching operations on the data storage unit according to a caching criterion to thereby obtain and store cache data in the cache memory, and (c) sending the cache data to an analyst server via the data transmission interface so as for the analyst server to analyze the cache data and thereby generate an analysis result.

### BRIEF DESCRIPTION OF THE SEVERAL VIEWS OF THE DRAWINGS

In order that the advantages of the invention will be readily understood, a more particular description of the invention, briefly described above, will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a diagram of a data analysis system according to an embodiment of the present invention.

FIG. 2 is a diagram of a caching device according to an embodiment of the present invention.

FIG. 3 is a flowchart of a method according to an embodiment of the present invention.

### DETAILED DESCRIPTION

Embodiments of the present invention select useful information from big data in a short period of time with methods and tools to analyze the useful information thus selected. For example, traffic on highways can be instantly smoothened by quickly identifying a key section of a road rather than the road in its entirety, analyzing its traffic flow data, and allocating lanes accordingly.

Instead of analyzing all the data in a storage device directly, the present invention discloses enabling a caching device to monitor a data access pattern of a client terminal with respect to the storage device in real time, cache appropriate or crucial data replicas from the storage device according to caching criteria to meet a wide variety of objectives and needs of data analysis, and send out the data replicas to serve as samples for data analysis.

For example, if hot data is regarded as a caching criterion, then the caching device will retrieve and send the hot data to the analyst server for analysis. The hot data, for example, includes video, personal or corporate data or stock-related data, which is intensively accessed within a fixed period of time for analysis by the analyst server. Afterward, characteristics of hot data are used in making operation policy, for example, placing popular video data at a server near the client terminal to enhance performance and service quality.

According to an embodiment of the present invention, a data analysis system comprises an analyst server, at least one data storage unit, a client terminal independent of the analyst server, and a caching device independent of the analyst server. The caching device further comprises a cache memory, a data transmission interface, and a controller connected to the analyst server, the client terminal, and the storage unit. The controller obtains a data access pattern of the client terminal with respect to the at least one data storage unit, performs caching operations on the at least one data storage unit according to a caching criterion to obtain and store cache data in the caching memory, and sends the cache data to the analyst server via the data transmission interface, such that the analyst server analyzes the cache data to generate an analysis result.

In another embodiment, the present invention further provides a caching device for use in the data analysis system and a data processing method for use with the caching device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

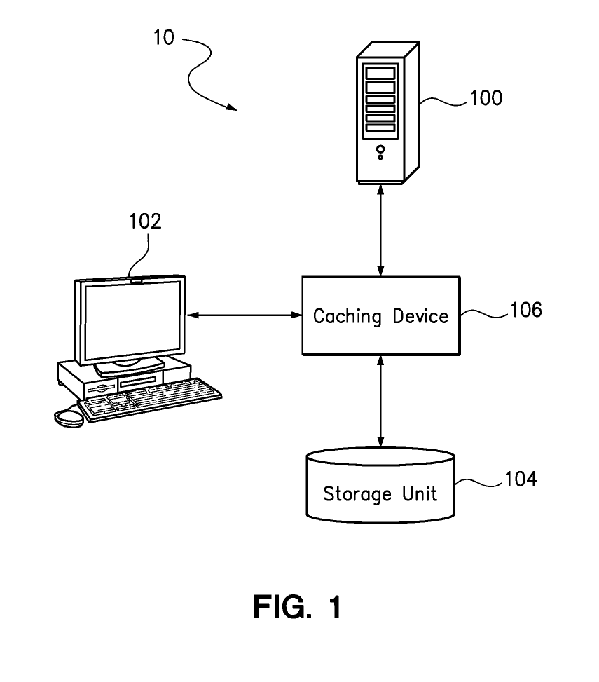

Referring now to FIG. 1 through FIG. 3, computer systems, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

<Data Analysis System>

FIG. 1 is a block diagram of a data analysis system 10 according to an embodiment of the present invention. The data analysis system 10 comprises an analyst server 100, a client terminal 102, a storage unit 104, and a caching device 106. FIG. 1 is not restrictive of the quantity of an analyst server, a storage unit, a client terminal, and a caching device of the data analysis system of the present invention.

The analyst server 100 is a server, for example, IBM's System X, Blade Center or eServer server, which has programs for executing data analytic applications, such as Microsoft's SQL Server products.

The client terminal 102 is independent of the analyst server 100 and is exemplified by a personal computer, a mobile device, or another server, which does not limit the present invention.

The storage unit 104 may, for example, be in the form of a network-attached storage (NAS), a storage area network (SAN), or a direct attached storage (DAS) to enable the client terminal 102 to perform data access. However, the storage unit 104 can be directly connected to the client terminal 102 to function as a local device for use with the client terminal 102, and the present invention is not limited thereto.

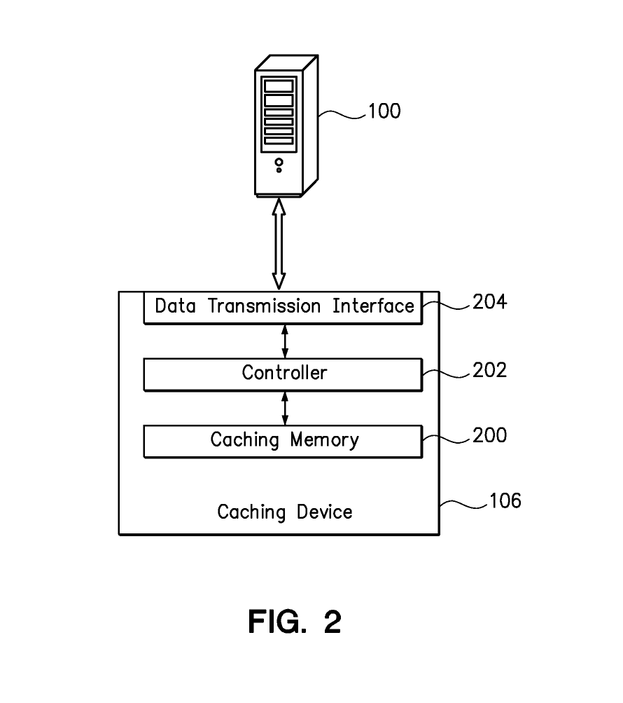

The caching device 106 is also independent of the analyst server 100. Related details are described below in conjunction with FIG. 2.

The analyst server 100, the client terminal 102, the storage unit 104, and the caching device 106 are linked, as needed, by a local bus, a local area network, the Internet, or any other data transmission channel to perform data communication. In a preferred embodiment, the caching device 106 is directly linked to the storage unit 104 via a local bus (not shown). To enhance stability and security, the analyst server 100 is independent of the client terminal 102, the storage unit 104, and the caching device 106.

<Caching Device>

FIG. 2 is a block diagram of the caching device 106 in accordance with one embodiment. The caching device 106 further comprises a cache memory 200, a controller 202, and a data transmission interface 204. Preferably, the cache memory 200 is a solid-state memory (for example, a flash memory) which reads and writes data faster than the storage unit 104 does, though the present invention is not limited thereto. The cache memory 200 may, for example, be in the form of a hard disk drive or any other storage device. The cache memory 200 and the controller 202 are linked, as needed, by a local bus, a local area network, the Internet, or any other data transmission channel to perform data communication.

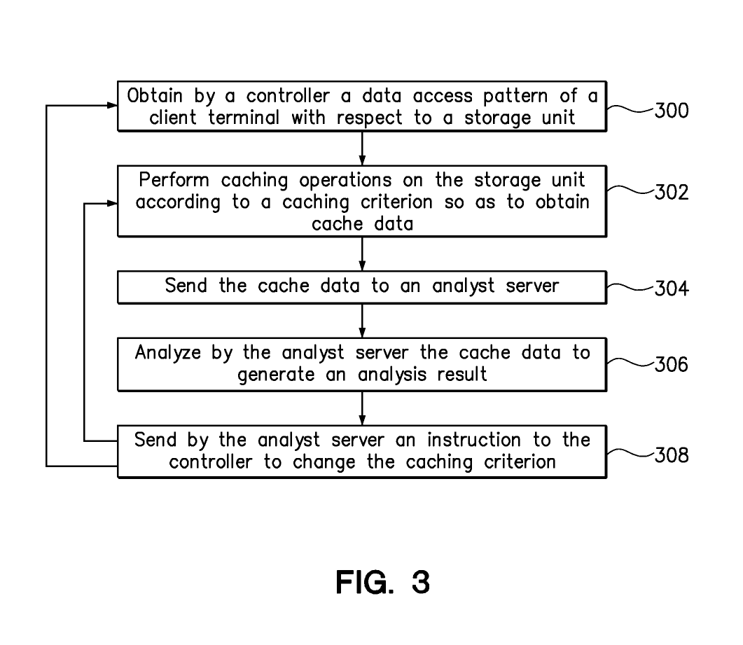

The controller 202 is able to perform conventional caching operations and stores cache data (that is, replicas of specific data in the storage unit 104) in the cache memory 200. Hence, the client terminal 102 (as shown in FIG. 1) reads and writes data from the cache memory 200 directly, rather than reads and writes data from the storage unit 104 slowly. The improvements of the controller 202 and its conventional counterparts are described below in conjunction with the flow chart of FIG. 3.

<Caching Criteria>

Step 300: the controller 202 monitors how the client terminal 102 performs data access to the storage unit 104 within a given period and calculates a data access pattern, e.g., access frequency. In this embodiment, the data access pattern is provided as a log of data access performed by the client terminal 102 to the storage unit 104 within a given period, and thus those portions of the data access pattern which are not related to the present invention are omitted.

Step 302: in this step, the controller 202 performs caching operations on the storage unit 104 according to a caching criterion so as to obtain cache data (that is, replicas of specific data in the storage unit 104) and store the cache data in the cache memory 200.

In an embodiment, a caching criterion may relate to a given access frequency, and thus cache data may be defined as data (i.e., hot data) acquired as a result of access by the client terminal 102 to the storage unit 104 within a given period when the access frequency exceeds a given value. Alternatively, cache data may be defined as data (i.e., cold data) acquired at an access frequency below a given value. Likewise, it is also feasible to set the caching criterion to a given range of access frequency.

In another embodiment, a caching criterion may relate to a given access sequence. For example, cache data may be defined as data, which consists of the latest 1000 pieces of data or the earliest 500 pieces of data, acquired as a result of access by the client terminal 102 to the storage unit 104. Likewise, it is feasible to set the caching criterion to a given range of access sequence.

In yet another embodiment, a caching criterion may relate to a given access period. For example, cache data may be defined as data acquired as a result of access by the client terminal 102 to the storage unit 104 before or after a specific point in time. Likewise, it is feasible to set the caching criterion to a given range of access period.

In a further embodiment, a caching criterion may relate to a given data address. For example, cache data may be defined as data acquired as a result of access by the client terminal 102 to the storage unit 104 at a given data address. Likewise, it is feasible to set the caching criterion to a given range of data addresses.

In a still further embodiment, a caching criterion may relate to a given data size. For example, cache data may be defined as data acquired as a result of access by the client terminal 102 to the storage unit 104, wherein the size of the data acquired is larger or smaller than a given data size. Likewise, it is feasible to set the caching criterion to a given range of data size.

In another embodiment, a caching criterion may relates to a given string. For example, cache data may be defined as data acquired as a result of access by the client terminal 102 to the storage unit 104, wherein the data acquired has a given string. Likewise, it is feasible to set the caching criterion to any particular combination of strings.

In an additional embodiment, a caching criterion may relate to a given value of at least a parameter contained in the data access pattern. Hence, in step 300, the caching criterion may be defined as a given value of a parameter available in the data access pattern calculated by the controller 202. For example, if the data access pattern comprises a data-related file name, a given file name can function as the caching criterion.

Step 302 does not necessarily follow step 300. Step 300 and step 302 can take place simultaneously, provided that cache data in step 302 is acquired after step 300.

Step 304: the controller 202 sends cache data stored in the cache memory 200 to the analyst server 100 via the data transmission interface 204. If the caching device 106 is mounted on a motherboard (not shown), the data transmission interface 204 can be a PCI-e interface or an InfiniBand interface.

Step 306: the analyst server 100 analyzes cache data to generate an analysis result. For example, an analysis result may be generated using SQL Server products of Microsoft Corporation, which are applicable to data mining as described in “Predictive Analysis with SQL Server 2008”, a White Paper published by Microsoft Corporation. The present invention is not restrictive of a way of analyzing cache data.

Step 308: selectively, the analyst server 100 sends an instruction to the controller 202 to change the caching criterion, and then the process flow of the method goes back to step 300, or will go back to step 302 if the data access pattern need not be updated. Afterward, the process flow of the method proceeds to steps 304-306.

The foregoing embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A data analysis system, comprising:
an analyst server;
at least one data storage unit;
a client terminal independent of the analyst server; and
a caching device independent of the analyst server, the caching device further comprising a cache memory, a data transmission interface, and a controller in communication with the analyst server, the client terminal, and the storage unit, wherein the controller obtains a data access pattern of the client terminal with respect to the storage unit and performs caching operations on the storage unit according to a caching criterion to obtain and store cache data in the cache memory and send the cache data to the analyst server via the data transmission interface, thereby allowing the analyst server to analyze the cache data and generate an analysis result.

2. The data analysis system of claim 1, wherein the caching criterion is specified or changeable by the analyst server.

3. The data analysis system of claim 2, wherein the caching criterion relates to a given access frequency.

4. The data analysis system of claim 2, wherein the caching criterion relates to a given access sequence.

5. The data analysis system of claim 2, wherein the caching criterion relates to a given access period.

6. The data analysis system of claim 2, wherein the caching criterion relates to a given data address.

7. The data analysis system of claim 2, wherein the caching criterion relates to a given data size.

8. The data analysis system of claim 2, wherein the caching criterion relates to a given string.

9. The data analysis system of claim 2, wherein the caching criterion relates to a given value of at least a parameter contained in the data access pattern.

10. A caching device, comprising:
a cache memory;
a data transmission interface; and
a controller connected to the cache memory and the data transmission interface, wherein the controller obtains a data access pattern of a client terminal with respect to a storage unit and performs caching operations on the storage unit according to a caching criterion to obtain and store cache data in the cache memory and send the cache data to an analyst server via the data transmission interface.

11-13. (canceled)
